(19) United States
(12) Patent Application Publication
(10) Pub. No.: US 2007/0158379 A1
(43) Pub. Date: Jul. 12, 2007

(54) Hitch mounted ladder rack

(76) Inventor: William Clinton Bell, Calgary (CA)

Correspondence Address: Red Gallagher, 7420 Milner Dr., Colorado Springs, CO, 80920, US

(21) Appl. No.: 11/329,931

(22) Filed: Jan. 12, 2006

(51) Int. Cl. B60R 9/00; B60R 11/00

(52) U.S. Cl. 224/504; 224/519; 224/532; 224/535

(57) ABSTRACT

A ladder rack to carry a ladder on a vehicle having a receiver hitch comprises: i) a male hitch member having one end dimensioned for close reception within the receiver hitch and an other opposite end; ii) an upright leg having a lower end portion connected to the other opposite end portion of the male hitch member and an other upper end portion; iii) a ladder supporting fork extending rearwardly and upwardly from the upper end portion of the leg; and, iv) an upper retention member to retain the ladder on the ladder rack when it is bounced, said upper retention member extending rigidly rearwardly from an upper end portion of the leg, so that if the ladder bounces while being carried its upward movement will be limited by the rigid upper retention member, and so that the ladder may be loaded and unloaded from the ladder rack without having to move the ladder retention member. When the male hitch member is received within the receiver hitch and the ladder is thereafter slid over and on the ladder fork. In a preferred aspect of this invention the ladder support member comprises two lateral spaced forks and the ladder retention also member comprises two lateral spaced forks similar in length and appearance to the ladder supporting forks.

### FIELD OF TH INVENTION

This invention relates to more conveniently carrying step ladders on passenger vehicles, sports utility vehicles, or a pick-up trucks having a receiver hitch mounted thereon. More particularly this invention relates to a ladder rack which slides within and is carried by the receiver hitch on the vehicle. The ladder rack carries ladders thereon in an upright position.

### BACKGROUND OF THE INVENTION

It is frequently necessary to carry a ladder on a sports utility vehicle or a pick-up truck having a topper mounted thereon. Currently ladders must be carried inside the rear of the vehicle thereby substantially reducing available storage space. Frequently a carried ladder must extend into the space between the front seats; or alternatively, the rear door (or trunk lid) must be left open to allow the ladder to extend from the rear of the vehicle. Leaving the rear door of a sports utility vehicle open allows road dust and exhaust to enter the passenger compartment. A more convenient way to carry a ladder is needed. A ladder rack which does not substantially reduce available load capacity of the vehicle and which enables the rear door of the vehicle to be closed while carrying a ladder is disclosed herein.

Most frequently when a ladder is used it is necessary to haul additional tools and equipment for work in conjunction with the ladder. It also would be desirable to have a ladder rack which is easily mounted, or removed from a vehicle so that it is convenient to remove the ladder rack when it is not needed. And finally it is desirable to have a ladder rack which can be temporarily shifted to facilitate access through the rear door of the vehicle to objects carried within the rear of the vehicle.

### OBJECTS OF THE INVENTION

It is an object of this invention to disclose a ladder rack which can be used on a passenger vehicle, sports utility vehicle, or a pick-up truck having a topper mounted thereon. It is an object of this invention to disclose a ladder. rack which does not reduce the load carrying capacity of the vehicle. It is yet a further object of this invention to disclose a ladder rack which allows a ladder to be conveniently lifted on and off the vehicle from ground level without having to access the interior of the vehicle. It is yet a further object of this invention to disclose a ladder rack which can temporarily shift out of the way, to access the interior of the vehicle through a rear door of the vehicle. It is a final object of this invention to disclose a ladder rack which can be quickly, initially and subsequently, mounted and removed from a vehicle, without tools, by a user.

One aspect of this invention provides for a ladder rack to carry a ladder on a vehicle having a receiver hitch comprising: i) a male hitch member having one end dimensioned for close reception within the receiver hitch and an other opposite end; ii) an upright leg having a lower end portion connected to the other opposite end portion of the male hitch member and an other upper end portion; iii) a ladder supporting member extending rearwardly and upwardly from the upper end portion of the leg; and, iv) an upper retention member to retain the ladder on the ladder rack when it is bounced, said upper retention member extending rigidly rearwardly from an upper end portion of the leg, so that if the ladder bounces while being carried its upward movement will be limited by the rigid upper retention member, and so that the ladder may be loaded and unloaded from the ladder rack without having to move the ladder retention member. When the male hitch member is received within the receiver hitch and the ladder is next slid over and on the ladder fork so that it can be carried.

In a preferred aspect of this invention the ladder support member comprises two lateral spaced forks and the ladder retention also member comprises two lateral spaced forks similar in length and appearance to the ladder supporting forks.

Various other objects, advantages and features of this invention will become apparent to those skilled in the art from the following description in conjunction with the accompanying drawings.

### FIGURES OF THE INVENTION

FIG. 1 is a perspective view of a vehicle having a receiver hitch mounted ladder rack and ladder carried thereon.

FIG. 2 is an enlarged perspective view of the ladder rack shown in FIG. 1 rotated downwardly to allow access through a rear door of the vehicle.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

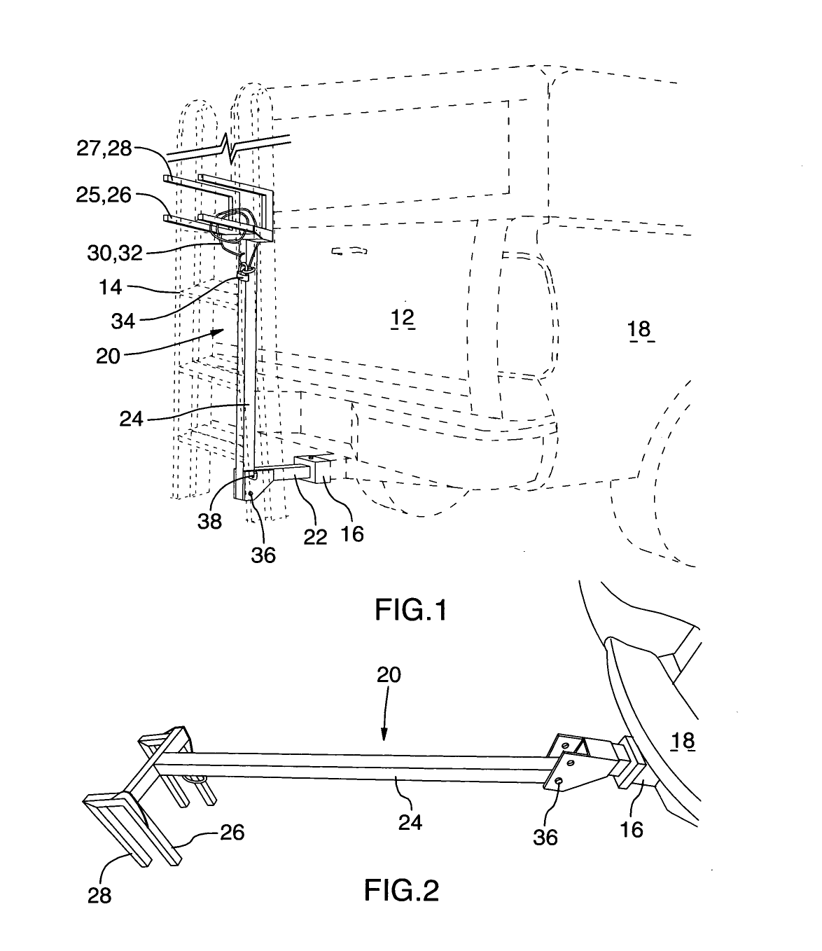

Turning now to the drawings and more particularly to FIG. 1 we have a perspective view of a vehicle 18 having a receiver hitch 16 mounted ladder rack 20 and ladder 14 carried thereon. Most generally a ladder rack 20 to carry a ladder 14 on a vehicle 18 having a receiver hitch 16 comprises: i) a male hitch member 22 having one end dimensioned for close reception within the receiver hitch 16 and an other opposite end; ii) an upright leg 24 having a lower end portion connected to the other opposite end portion of the male hitch member 22 and an other upper end portion; iii) a ladder supporting member 25 extending rearwardly and upwardly from the upper end portion of the leg 24; and, iv) an upper retention member 27 to retain the ladder 14 on the ladder rack 20, said upper retention member 27 extending rigidly rearwardly from an upper end portion of the leg 24, so that if the ladder 14 bounces while being carried its upward movement will be limited by the rigid upper retention member 27, and so that the ladder 14 may be loaded and unloaded from the ladder rack 20 without having to move the ladder retention member 27. Wherein use after the male hitch member 22 is received within the receiver hitch 16 and the ladder 14 is next slid over and on the ladder fork 26 the ladder 14 can be carried.

In a preferred embodiment of the invention the ladder support member 25 comprises two lateral spaced forks 26. Most preferably the ladder retention member 27 slopes up and rearwardly parallel to the ladder support member 25. In the most preferred embodiment of the invention the ladder support member 25 comprises two laterally spaced forks 26. The ladder retention member 27 also comprises two lateral spaced forks 28 similar in appearance to the two lateral spaced forks 26 which comprise the ladder support member 25. The ladder forks 26, 28 also have sufficient length to carry two ladders 14, back to back, on the ladder rack 20.

A rack lock means 30 is provided to prevent unintended removal of the ladder 14 from the ladder rack 20. Most preferably the rack lock means 30 comprises a wire rope 32 having one end attached to the ladder rack 20 and the other opposite end suitable for padlocking 34 to the rack 20 after the rope 32 has been wrapped around the ladder 14 carried thereon.

FIG. 2 is an enlarged perspective view of the ladder rack 20 shown in FIG. 1 rotated downwardly to allow access through a rear door 12 of the vehicle 18. When a hinge 36 is positioned between the other end of the male member 22 and the lower end of the leg 24 then when the rack 20 is carried by the vehicle 18, the leg 24 can swing open and down, thereby unblocking access into the vehicle 18 from a rear side portion thereof. In the most preferred embodiment of the invention the leg 24 is locked in an upwardly extending position by a removable pin 38.

While the invention has been described with preferred specific embodiments thereof, it will be understood that this description is intended to illustrate and not to limit the scope of the invention, which is defined by the following claims.

I claim:

1) A ladder rack to carry a ladder on a vehicle having a receiver hitch comprising:
i) a male hitch member having one end dimensioned for close reception within the receiver hitch and an other opposite end;
ii) an upright leg having a lower end portion connected to the other opposite end portion of the male hitch member and an other upper end portion;
iii) a ladder support member extending rearwardly and upwardly from the upper end portion of the leg; and,
iv) an upper retention member to retain the ladder on the ladder rack, said upper retention member extending rigidly rearwardly from an upper end portion of the leg, so that if the ladder bounces while being carried its upward movement will be limited by the rigid upper retention member, and so that the ladder may be loaded and unloaded from the ladder rack without having to move the ladder retention member;
wherein use the male hitch member is received within the receiver hitch and the ladder is next slid over and on the ladder fork so that it can be carried.

2) A ladder rack as in claim 1 wherein the ladder support member comprises two lateral spaced forks.

3) A ladder rack as in claim 2 wherein the ladder retention member slopes up and rearwardly parallel to the ladder support member.

4) A ladder rack as in claim 2 wherein the ladder retention member comprises two lateral spaced forks similar in length and appearance to the lateral spaced forks of the ladder support member.

5) A ladder rack as in claim 4 the ladder forks have sufficient length to carry two ladders, back to back, on the ladder rack.

6) A ladder rack as in claim 5 further comprising a rack lock means to prevent unintended removal of the ladder from the ladder rack.

7) A ladder rack as in claim 5 wherein the rack lock means comprises a wire rope having one end attached to the ladder rack and the other opposite end suitable for padlocking to the rack after the rope has been wrapped around the ladder carried thereon.

8) A ladder rack as in claim 6 further comprising a hinge positioned between the other end of the male member and the lower end of the leg so that when the rack is carried by the vehicle, the leg can swing open and down, thereby unblocking access into the vehicle from a rear side portion thereof.

9) A ladder rack as in claim 8 wherein the leg is locked in an upwardly extending position by a removable pin.

10) A ladder rack as in claim 4 wherein the ladder rack is fabricated from square tubing.
